(19) United States
(12) Patent Application Publication
(10) Pub. No.: US 2017/0356401 A1
(43) Pub. Date: Dec. 14, 2017

(54) INTAKE MANIFOLD

(71) Applicant: Roki Co., Ltd., Hamamatsu-Shi (JP)

(72) Inventors: TAKAZUMI TOYOSHIMA, Hamamatsu-Shi (JP); Yusuke MURAMATSU, Hamamatsu-Shi (JP)

(73) Assignee: Roki Co., Ltd., Hamamatsu-Shi (JP)

(21) Appl. No.: 15/610,953

(22) Filed: Jun. 1, 2017

(30) Foreign Application Priority Data
Jun. 9, 2016 (JP) 2016-115577

(51) Int. Cl. F02M 35/104; F02M 35/10

(52) U.S. Cl. CPC F02M 35/104; F02M 35/10321; F02M 35/1036

(57) ABSTRACT

The present invention provides an intake manifold which can improve distribution of a drawn fluid among cylinders of an internal combustion engine without major changes. An intake manifold made of resin includes: an intake port 21 formed by welding together a base member 2 and a cover member 5 and adapted to take in outside air; a chamber 10 connected with the intake port 21 through a connecting passage 25 formed by including a cavity portion 50; and plural discharge ports 27 connected with one another through a branch passage branching from the chamber 10, wherein a shielding member 60 adapted to shield the cavity portion 50 and function as a wall surface of the connecting passage 25 is provided in the connecting passage 25.

### BACKGROUND OF THE INVENTION

### Field of the Invention

The present invention relates to a resin-made intake manifold installed to introduce outside air into an internal combustion engine.

### Description of the Related Art

Conventionally an intake manifold is known which filters air taken in by an internal combustion engine from outside, using an air cleaner and then distributes and supplies the air to cylinders of an internal combustion engine (see Patent Document 1: Japanese Patent Laid-Open No. 2013-160177).

The intake manifold described in Patent Document 1 distributes and supplies the air filtered by the air cleaner to the cylinders of the internal combustion engine through a chamber.

The intake manifold described in Patent Document 1 is provided with air supply ports in a lengthwise direction of the chamber to supply air to the respective cylinders of the internal combustion engine. Because an air inlet is provided at one end of the chamber, the closer the air supply port to the air inlet, the more readily air is drawn in. This produces differences in intake air quantity among the cylinders.

Also, to deal with the above-mentioned fact that there are differences among quantities of air drawn into different cylinders, an intake manifold is known which provides an air inlet in a center of a chamber and arranges cylinders evenly on opposite sides of the air inlet by giving consideration to distribution of air quantities drawn into the cylinders (see Patent Document 2: Japanese Patent Laid-Open No. 2005-48735).

In configurations of the conventional intake manifolds, an intake port needs to be placed on a lateral side of the chamber due to a layout problem, making it difficult to provide the air inlet in the center of the chamber as with Patent Document 2 by providing a connecting passage adapted to connect the intake port and the chamber in the center of the chamber without changing shape and size greatly. Also, the conventional intake manifolds are constructed by heat-welding plural members formed by resin molding, but with resin molding, the larger a product thickness, the more likely shrinkage is to occur. Thus, to prevent the shrinkage, a recess is formed by intentionally reducing thickness in a relatively thick portion. This produces a dead space around the recess.

### SUMMARY OF THE INVENTION

The present invention has been made in view of the above problem and has an object to provide an intake manifold which can improve distribution of an intake fluid among cylinders of an internal combustion engine without major changes.

To solve the above problem, the present invention adopts the following configuration. Note that although reference numerals used in drawings are shown in parentheses to facilitate understanding of the present invention, the present invention is not limited by this.

The above and other objects can be achieved according to the present invention by providing an intake manifold (1) made of resin and including: an intake port (21) formed by welding together a base member (2), a port member (6) having a cavity portion (50), and a port cover member (7) and adapted to take in outside air; a chamber (10) connected with the intake port through a connecting passage (25) formed by including the cavity portion; and a plurality of discharge ports (27) connected with one another through a branch passage (35) branching from the chamber, wherein the connecting passage or the branch passage is formed by including the cavity portion, and a shielding member (60) adapted to shield the cavity portion and function as a wall surface of the connecting passage is provided in the connecting passage or the branch passage.

Also, in the intake manifold according to the present invention, the cavity portion is formed in a portion where the chamber and the connecting passage are connected; the shielding member is formed in a curved shape, being expanded in diameter toward an open end; and a surface of the shielding member is formed smoothly.

Also, in the intake manifold according to the present invention, the connecting passage and the branch passage are formed on different planes of the port member; and the cavity portion is formed on one face of the port member, that is, on that face of the port member on which the connecting passage is formed.

Also, in the intake manifold according to the present invention, the connecting passage and the branch passage are formed on different planes of the port member; and the cavity portion is formed on another face of the port member, that is, on that face of the port member on which the branch passage is formed.

Also, in the intake manifold according to the present invention, the shielding member is provided by being sandwiched between the port member and the base member or between the port member and the port cover member.

Also, in the intake manifold according to the present invention, the shielding member is integrated when the port member is welded in contact with both the base member and the shielding member; and when the port member and the base member are placed in contact during welding, a gap is formed between the port member and the shielding member.

Also, in the intake manifold according to the present invention, a positioning portion (70) used to position the shielding member is formed on the base member and part of the shielding member is fitted in the positioning portion.

Whereas in an intake manifold, a portion having a cavity portion 50 conventionally cannot be used effectively on reasons of injection molding, by providing the connecting passage 25 in the portion having the cavity portion 50 and shielding the cavity portion 50 with the shielding member 60, the intake manifold according to the present invention allows an intake fluid to be introduced from a center of the chamber 10 and thereby improves distribution of the intake fluid among cylinders of an internal combustion engine.

Also, using the configuration of the conventional intake manifold, since the connecting passage 25 is provided in a dead space, an intake manifold can be produced without major changes or capsizing.

### BRIEF DESCRIPTION OF THE DRAWINGS

In the accompanying drawings:

FIG. 1 is a schematic diagram showing an appearance of an intake manifold according to a first embodiment;

FIG. 2 is an exploded schematic diagram for explaining a structure of the intake manifold according to the first embodiment;

FIG. 3 is a schematic diagram showing an example of a connecting passage;

FIG. 4 is a bottom view of a port member;

FIG. 5 is a plan view of the port member;

FIG. 6 is a schematic diagram showing an example of a cavity portion;

FIG. 7 is a schematic diagram showing an example of how a shielding member is mounted in the cavity portion;

FIG. 8 is a schematic diagram showing an appearance example of the shielding member;

FIG. 9A shows an assembled condition of the shielding member, and is a schematic diagram showing a section in a front-rear direction;

FIG. 9B shows an assembled condition of the shielding member, and is a schematic diagram showing a section in a left-right direction;

FIG. 10A shows an assembled condition of the shielding member, and is an enlarged view of part X in FIG. 9;

FIG. 10B shows an assembled condition of the shielding member, and is a schematic diagram showing arrangement of various members before welding by enlarging part Y in FIG. 10A; and

FIG. 11 is a schematic diagram showing an assembled condition of a shielding member of an intake manifold according to a second embodiment.

### DETAILED DESCRIPTION OF THE PREFERRED EMBODIMENTS

Preferred embodiments of the present invention will be described hereunder with reference to the accompanying drawings. Note that the embodiments described below are not intended to limit the claimed invention and that a combination of all the features described in the embodiments is not necessarily essential for the solution of the present invention.

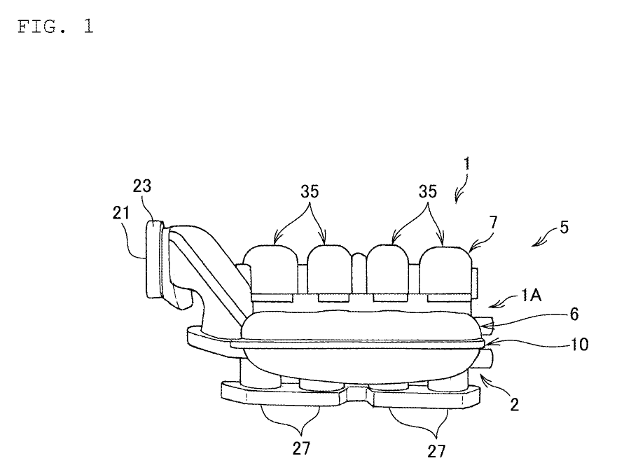

First, an intake manifold according to a first embodiment will be described with reference to FIGS. 1 to 10.

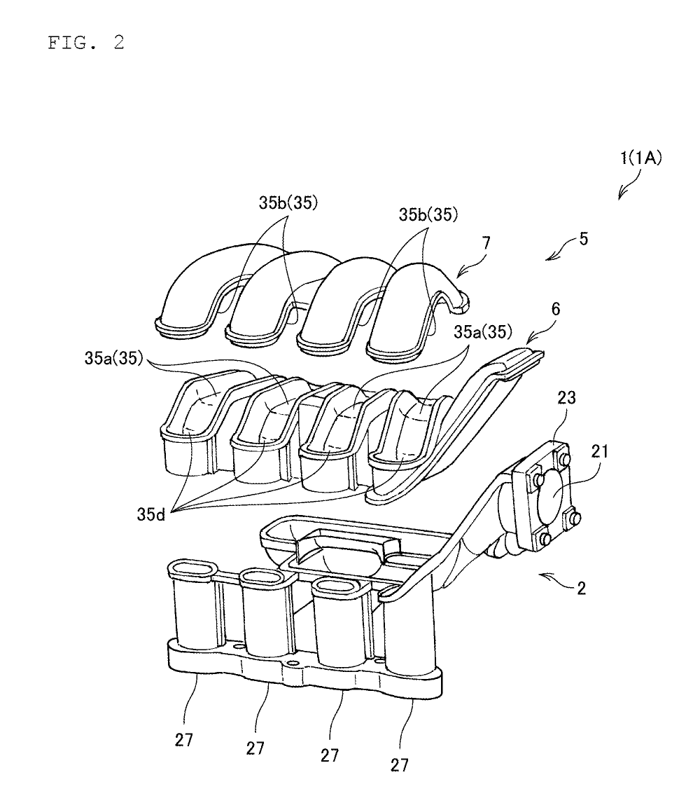

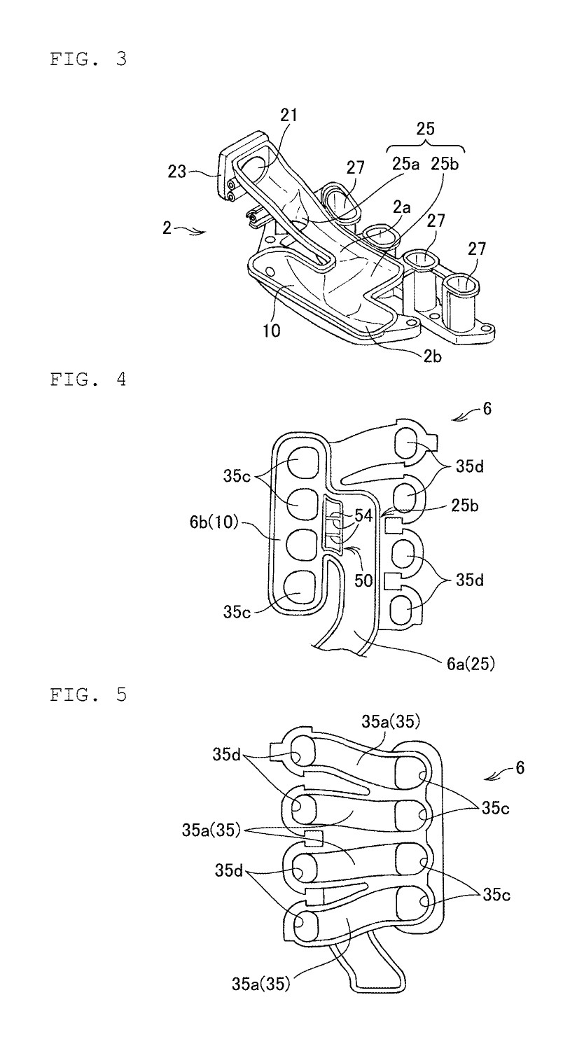

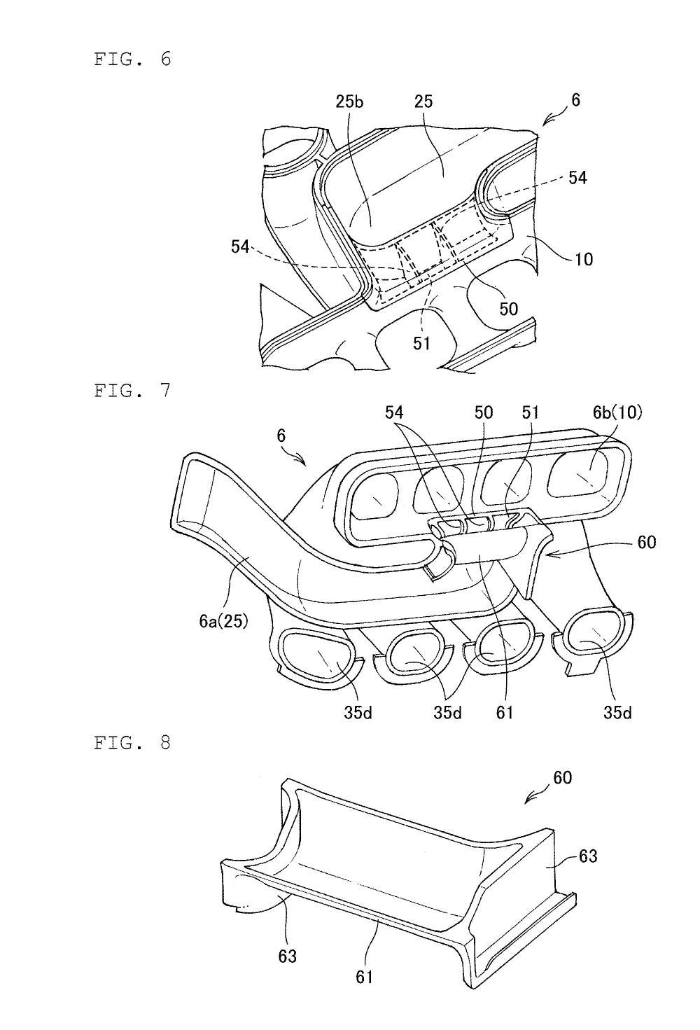

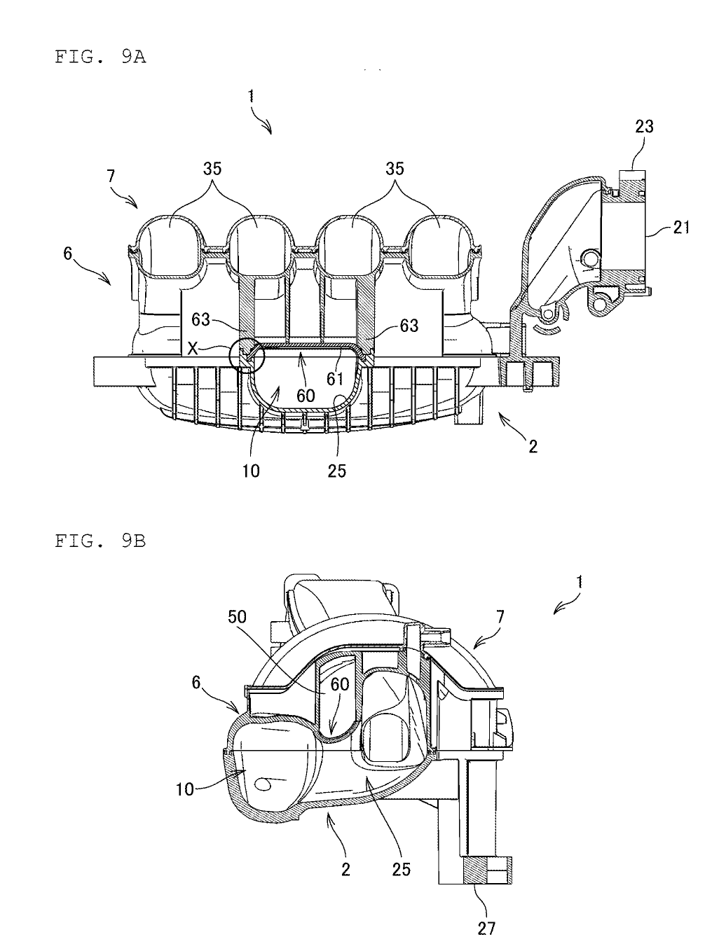

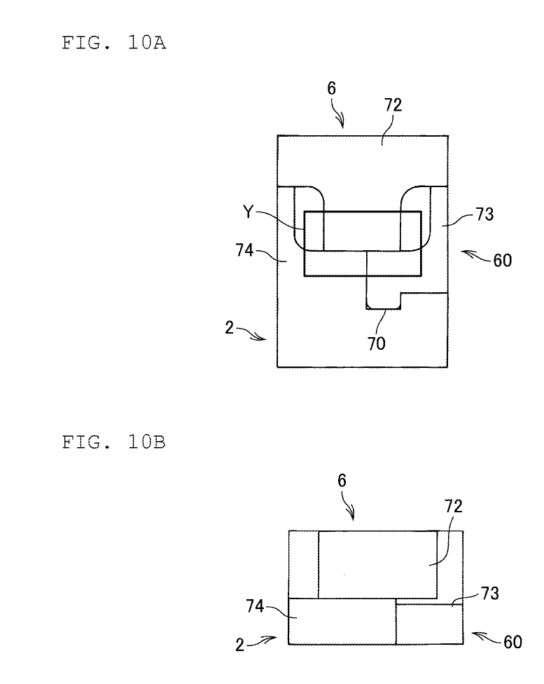

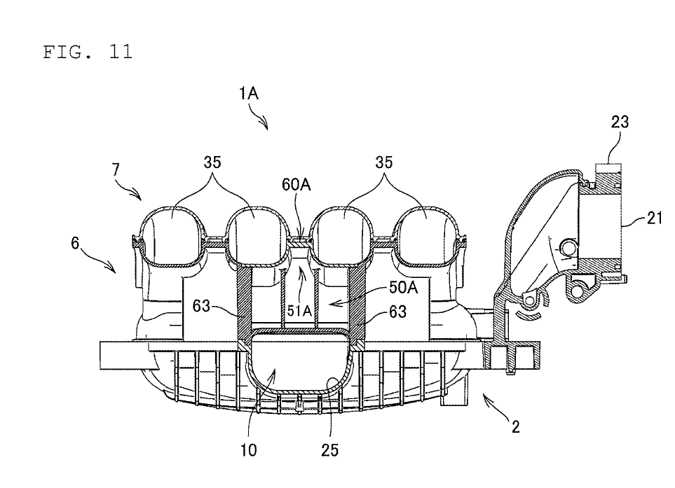

FIG. 1 is a schematic diagram showing an appearance of the intake manifold according to the present embodiment; FIG. 2 is an exploded schematic diagram for explaining a structure of the intake manifold according to the present embodiment; FIG. 3 is a schematic diagram showing an example of a connecting passage; FIG. 4 is a bottom view of a port member; FIG. 5 is a plan view of the port member; FIG. 6 is a schematic diagram showing an example of a cavity portion; FIG. 7 is a schematic diagram showing an example of how a shielding member is mounted in the cavity portion; FIG. 8 is a schematic diagram showing an appearance example of the shielding member; FIG. 9A shows an assembled condition of the shielding member, and is a schematic diagram showing a section in a front-rear direction; and FIG. 9B shows an assembled condition of the shielding member, and is a schematic diagram showing a section in a left-right direction; and FIG. 10A shows an assembled condition of the shielding member, and is an enlarged view of part X in FIG. 9; and FIG. 10B shows an assembled condition of the shielding member, and is a schematic diagram showing arrangement of various members before welding by enlarging part Y in FIG. 10A.

As shown in FIGS. 1 and 2, the intake manifold 1 includes, for example, a base member 2 and a cover member 5 provided covering upper part of the base member 2. The cover member 5 is formed by being divided into a port member 6 and a port cover member 7 placed on the port member 6.

The port member 6 is placed between the port cover member 7 placed on an upper side and the base member 2 placed on a bottom side and is assembled by welding the base member 2, for example, after the port member 6 and the port cover member are welded together. That is, the intake manifold 1 according to the present embodiment is formed by being divided, for example, into three members 2, 6, and 7 and is integrated when the members 2, 6, and 7 are assembled and welded together.

The base member 2, port member 6, and port cover member 7 are formed of thermoplastic synthetic resin such as polyamide group resin or polypropylene group resin. These members 2, 6 and 7 are welded together by generating frictional heat through application of vibration to weld surfaces among these members 2, 6 and 7 and applying pressure thereto using a pressure jig or slide jig. In addition, in the intake manifold 1 according to the present embodiment, welded portions of the base member 2, port member 6, and port cover member 7 are formed by being superposed in a vertical direction on the side of discharge ports 27 in branch passages 35 described later.

As shown in FIGS. 1 and 3, the chamber 10 is formed inside the intake manifold 1. As shown in FIG. 3, the chamber 10 is connected via the connecting passage 25 with an intake port 21 through which an intake fluid is introduced, and the intake fluid introduced through the intake port 21 is introduced into the chamber 10 via the connecting passage 25. Also, as shown in FIGS. 1 and 2, the chamber 10 is connected via the branch passages 35 with the plural discharge ports 27 connected to the respective cylinders of the internal combustion engine, the intake fluid introduced into the chamber 10 is distributed to the branch passages 35, and the distributed intake fluid is discharged to the discharge ports 27.

Note that the intake manifold 1 according to the present embodiment described herein is used for a so-called in-line four-cylinder internal combustion engine, in which four cylinders are arranged in line, and thus as many branch passages 35 as there are cylinders, i.e., four branch passages 35 are formed.

As shown in FIGS. 1 to 3, the intake port 21 is formed by opening to a flange 23 formed protruding toward a lateral end portion of the chamber 10. Note that the intake manifold 1 is attached to a throttle body (not shown) via the flange 23, where the throttle body is adapted to control the intake fluid.

As shown in FIG. 3, the connecting passage 25 includes a linear portion 25a extending rectilinearly into the intake manifold 1 and a bent portion 25b formed by bending to connect to central part of the chamber 10.

Also, as shown in FIGS. 1 and 2, the branch passages 35 are arranged side by side in a line by bending around an upper circumference of the intake manifold 1 and the discharge ports 27 are provided on a downstream side of the branch passages 35.

As shown in FIGS. 2 and 3, the intake port 21 and the discharge ports 27 are formed in the base member 2, on which an inner wall 2a and an inner wall 2b are formed, where the inner wall 2a makes up lower part of the connecting passage 25 along which the intake fluid introduced through the intake port 21 is introduced into the chamber 10 while the inner wall 2b makes up lower part of the chamber 10.

On the other hand, as shown in FIG. 4, an inner wall 6a making up upper part of the connecting passage 25 and an inner wall 6b making up upper part of the chamber 10 are formed on an undersurface of the port member 6. When the base member 2 and the port member 6 are integrated by welding, the connecting passage 25 cylindrical in shape and the chamber 10 with a predetermined space are formed.

Also, as shown in FIGS. 2 and 5, on a top surface of the port member 6 and an undersurface of the port cover member 7, grooves 35a and 35b arranged side by side in a line and forming part of the branch passages 35 are formed curving upward. Consequently, the branch passages 35 cylindrical in shape are formed when the port member 6 and the port cover member 7 are integrated by welding.

Also, as shown in FIGS. 4 and 5, an opening 35c connecting the branch passages 35 and the chamber 10 with each other and an opening 35d connecting the branch passages 35 and the discharge ports 27 with each other are formed in the port member 6. The intake fluid introduced into the chamber 10 is distributed to the branch passages 35 through the opening 35c and the intake fluid distributed to the branch passages 35 is discharged to the discharge ports 27 through the opening 35d.

In this way, in the intake manifold 1, the connecting passage 25 and the branch passages 35 are formed on different planes of the port member 6, intersecting each other at right angles, the intake port 21 adapted to take in outside air is connected with the chamber 10 through the connecting passage 25, and the chamber 10 is connected with the plural discharge ports 27 through the branch passages 35. Thus, the air introduced through the intake port 21 is introduced into the chamber 10 through the connecting passage 25, distributed to the branch passages 35 by the chamber 10, discharged to the discharge ports 27, and distributed to the cylinders of the internal combustion engine. Also, as shown in FIG. 3, the connecting passage 25 is connected to a substantially central part of the chamber 10, and the branch passages 35 branching from the chamber 10 are placed almost evenly on opposite sides of an exit from the connecting passage 25 as shown in FIG. 5. This makes it possible to easily improve distribution of intake air to the branch passages 35.

Also, as shown in FIGS. 4 and 6, the cavity portion 50 is formed on the undersurface of the port member 6 to prevent shrinkage during injection molding. The cavity portion 50 is formed being exposed to part of the connecting passage 25 and is provided with an opening 51 on a flow path of the intake fluid flowing in from the intake port 21. Therefore, part of the intake fluid flows into the cavity portion 50, obstructing flow of the intake fluid in the connecting passage 25.

According to the present embodiment, the cavity portion 50 is formed where the bent portion 25b of the connecting passage 25 is connected to the chamber 10, ribs 54 for reinforcement are provided in the cavity portion 50, and inner part of the cavity portion 50 is divided into plural rooms.

Also, the intake manifold 1 according to the present embodiment is provided with the shielding member 60 adapted to shield the opening 51 of the cavity portion 50 as shown in FIG. 7. As shown in FIGS. 7 and 8, the shielding member 60 includes a base body 61 adapted to close the opening 51, and mounts 63 erected on opposite end portions of the base body 61 and used to mount the base body 61, shielding the opening 51.

As shown in FIG. 7, the surface of the shielding member 60 is formed smoothly, and functions as a wall surface of the connecting passage 25. Also, in the shielding member 60, central part of the base body 61 protrudes into the connecting passage 25 and central part of each mount 63 is formed into a curved shape protruding inward and expanded in diameter toward an open end, and consequently flow of the intake fluid passing through the connecting passage 25 is regulated and the intake fluid discharged into the chamber 10 is regulated so as to flow to a periphery of the chamber 10 without stagnating in the central part of the chamber 10.

Note that a connection port between the connecting passage 25 and the chamber 10 is formed into a so-called funnel shape, being expanded in diameter toward an open end to allow the intake fluid in the connecting passage 25 to be smoothly introduced into the chamber 10.

As shown in FIG. 9, the shielding member 60 is positioned on the base member 2 and mounted by being sandwiched between the port member 6 and the base member 2.

As shown in FIG. 10A, a recess 70 (positioning portion according to the present invention) for use to position the shielding member 60 is formed on the base member 2. An outer peripheral edge of the shielding member 60 is positioned by being fitted into the recess 70 by press fitting or the like and displacement of the shielding member 60 during welding is prevented by the recess 70. Note that the recess 70 may be formed by corresponding to either the entire outer peripheral edge or only part of the outer peripheral edge of the shielding member 60.

Also, in manufacturing the intake manifold 1, first the outer peripheral edge of the shielding member is positioned and mounted at the recess 70 of the base member 2 by means of press fitting or the like, and then as shown in FIG. 10A, a weld surface 72 of the base member 2 and a weld surface 73 of the shielding member 60 are placed in contact with a weld surface 74 of the port member 6 and welded, thereby integrating the members 2, 6, and 60.

Also, by giving consideration to the fact that weld strength between the port member 6 and base member 2 needs to be set higher than weld strength between the shielding member 60 and port member 6, as well as to manufacturing errors of the members 2, 6, and 60, shape of the shielding member 60 is designed appropriately such that a gap will be formed between the weld surface 74 of the port member 6 and the weld surface 73 of the shielding member 60 as shown in FIG. 10B during assembly of the port member 6 and base member 2 before welding.

Consequently, even if some manufacturing errors occur in the members 2, 6, and 60, the port member 6 and base member 2 can be set to be welded together before the port member 6 and shielding member 60, making it easy to manage welding allowance.

In this way, whereas in an intake manifold 1, a portion having a cavity portion 50 conventionally cannot be used effectively on reasons of injection molding, by providing the connecting passage 25 in the portion having the cavity portion and shielding the cavity portion 50 with the shielding member 60, the intake manifold 1 according to the present invention allows an intake fluid to be introduced from a center of the chamber 10 and thereby improves distribution of the intake fluid among cylinders of an internal combustion engine.

Also, using the conventional intake manifold 1, since the connecting passage 25 is provided in a dead space, the intake manifold 1 can be produced without major changes or upsizing.

Next, an intake manifold 1A according to a second embodiment will be described with reference to FIG. 11. In FIG. 11, components in common with FIG. 9 are denoted by the same reference numerals as the corresponding components in FIG. 9, and detailed description thereof will be omitted.

The present embodiment differs from the above embodiment in that a cavity portion 50A is provided on the top surface of the port member 6 and that a shielding member 60A is mounted at a different position on the cavity portion 50A.

That is, in the intake manifold 1A according to the present embodiment, an opening 51A of the cavity portion 50A is formed being exposed to part of the branch passages 35. A shielding member 60A adapted to shield the cavity portion 50A and function as wall surfaces of the branch passages 35 is provided in the branch passages 35.

Also, for example, of four grooves 35a arranged side by side in a line and forming part of the branch passages 35 formed on the top surface of the port member 6, the cavity portion 50A is formed in part of the two grooves 35a on an inner side, and the opening 51A of the cavity portion 50A is formed being exposed to part of the branch passages 35.

The shielding member 60A is attached to the opening 51A. As shown in FIGS. 11, the shielding member 60A is positioned on the base member 2 and mounted by being sandwiched between the port member 6 and the port cover member 7.

In this way, by providing the branch passages 35 in the portion having the cavity portion 50A and shielding the cavity portion 50A with the shielding member 60A, the intake manifold 1A according to the present embodiment, can prevent the flow of the intake fluid in the branch passages 35 from being obstructed by the intake fluid which flows into the cavity portion 50A by being distributed from the chamber 10 to the branch passages 35, introduce the intake fluid from the center of the chamber 10, and thereby improve distribution of the intake fluid among the cylinders of the internal combustion engine.

Also, using the conventional intake manifold 1, since the connecting passage 25 is provided in the dead space, the intake manifold 1 which allows the intake fluid to be introduced from the center of the chamber 10 can be produced easily without major changes or upsizing.

In the intake manifold 1 according to the present embodiment described above, the cover member 5 is made up of the port member 6 and the port cover member 7 configured separately, but may be made up of a single member as with the base member 2. Furthermore, the base member 2 may be made up of separate members as with the cover member 5.

Also, the intake manifold 1 according to the present embodiment described above is an intake manifold applied to an in-line four-cylinder internal combustion engine, but the type of internal combustion engine is not limited to this. For example, six Branch passages may be formed to apply the intake manifold 1 to an in-line six-cylinder internal combustion engine. In this way, the shape and number of Branch passages may be increased or decreased as appropriate according to the type of internal combustion engine to which the intake manifold 1 is applied. It will be apparent from the description of the appended claims that any form resulting from such changes or improvements is also included in the technical scope of the present invention.

The invention may be embodied in other specific forms without departing from the spirit or essential characteristics thereof.

The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2016-115577 filed on Jun. 9, 2016 including the specification, claims, drawings and summary is incorporated herein by reference in its entirety.

### REFERENCE SIGNS LIST

1, 1A Intake manifold
2 Base member
6 Port member
6a inner wall
7 Port cover member
10 Chamber
21 Intake port
27 Discharge port
25 Connecting passage
35 Branch passage
35a, 35b Groove
50, 50A Cavity portion
60, 60A Shielding member
61 Base body
63 Mount
72, 73, 74 Weld surface

1. An intake manifold made of resin and comprising: an intake port formed by welding together a base member, a port member having a cavity portion, and a port cover member and adapted to take in outside air; a chamber connected with the intake port through a connecting passage; and a plurality of discharge ports connected with one another through a branch passage branching from the chamber,
wherein the connecting passage or the branch passage is formed by including the cavity portion, and
a shielding member adapted to shield the cavity portion and function as a wall surface of the connecting passage is provided in the connecting passage or the branch passage.

2. The intake manifold according to claim 1, wherein:
the cavity portion is formed in a portion where the chamber and the connecting passage are connected; the shielding member is formed in a curved shape, being expanded in diameter toward an open end; and a surface of the shielding member is formed smoothly.

3. The intake manifold according to claim 1, wherein:
the connecting passage and the branch passage are formed on different planes of the port member; and the cavity portion is formed on one face of the port member, that is, on that face of the port member on which the connecting passage is formed.

4. The intake manifold according to claim 1, wherein:
the connecting passage and the branch passage are formed on different planes of the port member; and the cavity portion is formed on another face of the port member, that is, on that face of the port member on which the branch passage is formed.

5. The intake manifold according to claim 3, wherein
the shielding member is provided by being sandwiched between the port member and the base member or between the port member and the port cover member.

6. The intake manifold according to claim 5, wherein:
the shielding member is integrated when the port member is welded in contact with both the base member and the shielding member; and when the port member and the base member are placed in contact during welding, a gap is formed between the port member and the shielding member.

7. The intake manifold according to claim 1, wherein
a positioning portion used to position the shielding member is formed on the base member and part of the shielding member is fitted in the positioning portion.

8. The intake manifold according to claim 2, wherein:
the connecting passage and the branch passage are foinied on different planes of the port member; and the cavity portion is formed on one face of the port member, that is, on that face of the port member on which the connecting passage is formed.

9. The intake manifold according to claim 2, wherein:
the connecting passage and the branch passage are formed on different planes of the port member; and the cavity portion is formed on another face of the port member, that is, on that face of the port member on which the branch passage is formed.

10. The intake manifold according to claim 4, wherein
the shielding member is provided by being sandwiched between the port member and the base member or between the port member and the port cover member.

11. The intake manifold according to claim 2, wherein
a positioning portion used to position the shielding member is formed on the base member and part of the shielding member is fitted in the positioning portion.

12. The intake manifold according to claim 3, wherein
a positioning portion used to position the shielding member is formed on the base member and part of the shielding member is fitted in the positioning portion.

13. The intake manifold according to claim 4, wherein
a positioning portion used to position the shielding member is formed on the base member and part of the shielding member is fitted in the positioning portion.

14. The intake manifold according to claim 5, wherein
a positioning portion used to position the shielding member is formed on the base member and part of the shielding member is fitted in the positioning portion.

15. The intake manifold according to claim 6, wherein
a positioning portion used to position the shielding member is formed on the base member and part of the shielding member is fitted in the positioning portion.
